(19) United States
(12) Patent Application Publication
(10) Pub. No.: US 2026/0016808 A1
(43) Pub. Date: Jan. 15, 2026

(54) METHOD AND WORKFLOW FOR SIMPLIFIED TUNING OF 3D PRINTERS

(71) Applicant: Stratasys, Inc., Eden Prairie, MN (US)

(72) Inventor: Michael D. Bosveld, Bloomington, MN (US)

(21) Appl. No.: 19/101,759

(22) PCT Filed: Aug. 10, 2023
(86) PCT No.: PCT/US2023/071996

§ 371 Date: Feb. 6, 2025

Related U.S. Application Data
(60) Provisional application No. 63/371,898, filed on Aug. 19, 2022.

(51) Int. Cl. G05B 19/4093; B29C 64/393; B33Y 50/02

(52) U.S. Cl. CPC G05B 19/40937; B29C 64/393; B33Y 50/02; G05B 2219/49023

(57) ABSTRACT

A method includes providing values for a set of tunable build parameters corresponding to a print job specification to a user interface, and in response to user modification or selection of the tunable build parameters, computing values for a set of additional build parameters. A data package is created based on the values for the tunable build parameters and the set of additional build parameters and data files are then sent to one or more 3D printers and one or more slicing programs.

### BACKGROUND

3D printers consist of a collection of electrical and mechanical devices that create parts by adding and joining material to make parts from 3D model data, usually one layer at a time. 3D printers include several manufacturing technologies that build parts layer-by-layer. Each vary in the way they form parts and can differ in material selection, surface finish, durability, and manufacturing speed and cost. 3D printer technologies include but are not limited to:
Material extrusion-an additive manufacturing process in which material is selectively dispensed through a nozzle or orifice (also known as fused deposition modeling);
Material jetting—an additive manufacturing process in which droplets of build material are selectively deposited (also known as ink jetting);
Binder jetting—an additive manufacturing process in which a liquid bonding agent is selectively deposited to join powder materials;
Vat photopolymerization—an additive manufacturing process in which liquid photopolymer in a vat is selectively cured by light-activated polymerization (includes stereolithography and digital light curing processes);

Powder bed fusion-an additive manufacturing process in which thermal energy selectively fuses regions of a powder bed (includes selective laser sintering, high-speed sintering, and direct metal laser sintering); and
Directed energy deposition—an additive manufacturing process in which focused thermal energy is used to fuse materials by melting as they are being deposited

Before printing begins, a digital description of the part is converted into a sequence of build instructions for fabricating the part on a particular type of 3D printer, and which describe the order in which portions of the part are to be constructed. Software that converts part files to the build instructions is commonly referred to as a slicing program or a “slicer”. In addition to the geometry of model and the printer technology, the instructions depend on user-entered 3D printing parameters, such as material type(s), layer height, build speed, support structure settings, and the configuration of the 3D printer that will be used. In some printers, such as those using material extrusion technology, the slicing software will generate toolpaths that define paths for a print head or other printer hardware to traverse while building the part. In most printers, the material that is added is heated so that it will bond with other portions of the part. Ensuring that the printer places the proper amount of material, at the best temperature for bonding and shape retention and at the exact locations set out in the build instructions may require the setting of hundreds or even thousands of build parameters for the various electrical and mechanical devices in the printer.

### SUMMARY

A method includes providing values for a set of user-tunable build parameters corresponding to a print job specification in a first user interface and allowing user selection of settings for parameters in the set of user-tunable build parameters to thereby generate a set of user-selected build parameters. Values for a set of additional build parameters are computed based on the set of user selected build parameters and a data package is generated based on the set of user-selected build parameters and the set of additional build parameters. The data package is sent to one or more designated 3D printers where the one or more of the designated 3D printers are controlled to print one or more 3D parts based on the data package

In accordance with a further embodiment, a computer includes a memory having executable instructions and a processor executing the executable instructions to perform steps. The steps include receiving values for tunable build parameters for at least two combinations of printer type and part material and sending the received values for the at least two combinations of printer type and part material to a server. A single package is received from the server containing values for additional build parameters for each of the at least two combinations of printer type and part material. The additional build parameters for the at least two combinations of printer type and part material are sent to a 3D printer such that a part can be printed.

In accordance with a still further embodiment, a method includes providing values for a set of tunable build parameters to a computing device and in response, receiving from the computing device values for at least one conversion parameter and a set of additional build parameters. The value for the at least one conversion parameter is sent to a slicing program and the values for the set of additional build parameters are sent to a 3D printer where the 3D printer is controlled to print one or more 3D parts based on the values for the set of additional build parameters.

### BRIEF DESCRIPTION OF THE DRAWINGS

FIG. 1 provides a block diagram of a system used to convert a digital file into a part.

FIG. 2 provides a block diagram of a system for generating tuned parameter files.

FIG. 3 provides a flow diagram for generating a framework in accordance with one embodiment.

FIG. 4 provides an example of a user interface produced by a tuning application for defining a profile instance.

FIG. 5 provides a flow diagram of a method performed by a tuning application to provide parameter tuning.

FIG. 6 is an exemplary user interface used for tuning tunable parameters of a profile instance in accordance with one embodiment.

FIG. 7 is an exemplary user interface used for tuning tunable parameters of a profile instance in accordance with one embodiment.

FIG. 8 is an exemplary user interface used for tuning tunable parameters of a profile instance in accordance with one embodiment.

FIG. 9 is an exemplary user interface used for tuning tunable parameters of a profile instance in accordance with one embodiment.

FIG. 10 is an exemplary user interface used for tuning tunable parameters of a profile instance in accordance with one embodiment.

FIG. 11 is an exemplary user interface used for tuning tunable parameters of a profile instance in accordance with one embodiment.

FIG. 12 provides a flow diagram for creating a collection of profile instances referred to as a set.

FIG. 13 provides an example of a user interface used to create and edit a set.

FIG. 14 provides a flow diagram of a method of compiling a set into an upgrade package.

FIG. 15 provides a flow diagram of a method of designating slicing programs and printers to receive parameters from an encrypted package.

FIG. 16 provides a user interface for designating slicing programs and printers that are to receive parameters from an encrypted package.

FIG. 17 provides a method by which a tuning application installs packages on selected slicing programs and selected 3D printers.

FIG. 18 is a schematic front view of an exemplary 3D printer and workstation that the embodiments can be used with.

FIG. 19 is a schematic front view of an exemplary 3D printer and workstation that the embodiments can be used with.

FIG. 20 is a schematic front view of an exemplary 3D printer and workstation that the embodiments can be used with.

FIG. 21 is a block diagram of workstations that the various embodiments can be implemented on.

### DETAILED DESCRIPTION

Since different part materials have different thermal and mechanical characteristics, the build parameters used to control a 3D printer will be different for one material than for another material. Finding the ideal build parameters for a material is a time-consuming process requiring the building of hundreds of parts to determine which combination of the thousands of build parameters results in build parts with a desired strength and appearance. For many materials, build parameters that are ideal for building one part will not be ideal for building a different part because of the difference in the geometries of the two parts. Further, build parameters for one 3D printer will not be ideal for another 3D printer. In addition, materials that fall into a same class of material, such as ABS, but that are in fact distinct from each other, will have different optimal build parameters. A printer manufacturer (“OEM”) may provide or offer particular ‘material profiles’—configurations of build parameters tuned for printing a certain material or materials combination on a specific model of printer at given slice heights and using certain configurations of printer hardware and/or software. The material profiles are generated on a per material basis in a tuning process designed to enable successful builds in the majority of print jobs.

In addition to setting build parameters based on the material selection, changes in materials can require changes to the build instructions. Thus, conversion parameters used to convert the digital description of the part into build instructions (e.g., toolpaths) are material dependent, and these parameters desirably are also optimized by offering materials profiles for slicing each material combination.

Because material tuning is time-consuming, and possible material formulations and material combinations are limitless, material profiles offered are not exhaustive. Some printer systems are not configured to run materials that do not have an OEM material profile, and material selections are limited to a closed set of materials typically presented in a drop-down menu (“closed systems”). Selection of a listed material will load the stored material profile settings for that material. In such systems, user customization of parameters for printing the part is not available. Other systems allow users to self-select build parameters (perhaps in addition to offering OEM material profiles), thereby facilitating user-generated material profiles (“open systems”). While open systems enable an unlimited materials selection, the build parameters are not validated and therefore printing may require trial and error and may not be successful.

In accordance with the present embodiments, a parameter generating system is provided in which a user inputs a particularized subset of the build parameters for printing a selected material or material combination into a tuning application, and machine intelligence calculates or otherwise selects the remaining parameters to generate a packet for printing. As a starting point, the user creates a material profile by selecting either a generic part material type (e.g., ABS, ASA, PLA, nylon 12, TPU, etc.) or an OEM part material from a dropdown menu on a user interface of the tuning application, together with certain other print job settings which may include support material type, slice height, build speed, and nozzle orifice size. The user then is presented default values for the customizable parameters on a parameter selection user interface, and makes desired changes within prescribed limits, wherein the default values and the prescribed limits are specific to the material type selected by the user (typically, the default values will reflect a baseline material profile for the material type). The parameter generating system uses this subset of customized build parameters to identify all other build parameters and conversion parameters required to build a part for the associated material profile. These parameters are compiled into two files, one containing build parameters and the other containing conversion parameters. The system then installs the conversion parameters on one or more slicing programs designated by the user and installs the build parameters on one or more printers designated by the user. Some of these printers will be identical to each other and will use the same build parameters but will be given different parts to build. Other printers will be identical to each other but will be sent different parameter sets for printing either different materials or different build parameters for the same materials. Other 3D printers will be different from each other and will therefore also use different build parameters from each other. In one application, by setting these different 3D printers at the same time, test parts can be built in parallel thereby saving considerable time in finding the ideal 3D printer/material/build parameter combination for a given part or collection of parts.

To print parts using the generated parameters in accordance with embodiments of the present invention, a user installs a “chipped” part material cartridge in a designated printer. The chip corresponds to the part material type identified in the material profile. The user uploads a part file to the slicing program, enters or selects the chosen material profile into the slicing program, commands the slicing program to slice the part (which it will do using the installed conversion parameters), then instructs printing of the sliced part on the designated printer.

One goal of the parameter generator and workflow of the present disclosure is to enable a new material to be printed without having tuned the material for the print job. Another goal is to enable users to manipulate OEM material profiles in order to optimize the profiles to achieve desired results for a particular application or part geometry.

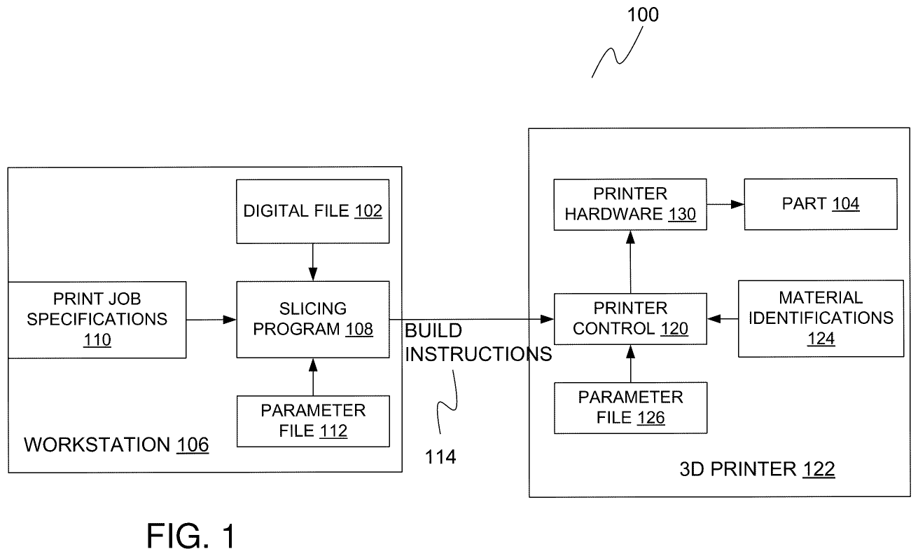

FIG. 1 provides a block diagram of a workflow 100 used to convert a digital file 102 into a part 104. Digital file 102 provides a 3-dimensional geometric description of the part to be constructed. Examples of such files are CAD files and STL files. Digital file 102 is provided to a workstation 106 that executes a slicing program 108. Slicing program 108 uses the digital file 102 together with print job specifications 110 and parameter file 112 to generate build instructions 114. Print job specifications 110 (together forming a ‘profile’ or ‘material profile’) are generally provided through a user interface and includes items such as the types of part material and support material that will be used, the type of printer to be used, the tip size for a print head in the printer if the printer contains such a print head, and the height of each part layer, known as the slice height. Those skilled in the art will recognize that other parameters can be in print job specifications 110. Parameter file 112 includes parameters associated with a variety of printer types, materials, tip sizes and slice heights. Slicing program 108 uses the parameters in parameter file 112 to determine the rates at which different portions of the part should be built and how each slice of the part should be constructed. Build instructions 114 includes instructions for the 3D printer that indicate how each layer of the part is to be constructed. For example, build instructions 114 indicates the sequence by which part material or support material is to be added to the part under construction and whether the part or support material is to be added as a continuation of a neighboring part or support material or is to be started as a break from a previous part deposition or support material deposition. In addition, build instructions 114 indicates when a new layer of part and support material is to be started. For some printers, the build instructions 114 is said to provide tool paths that indicate the path that printer hardware is to follow while adding material to the part.

Build instructions 114 is provided to a printer control 120 in a 3D printer 122. Printer control 120 also receives material identifications 124 that indicate the types of part material and support material that have been loaded into 3D printer 122. In accordance with some embodiments, the material identifications are retrieved from chips installed on spools containing the print material and support material. The spool chip can include and communicate information to the printer about the type of material, the diameter of the filament and/or the remaining length of the filament on the spool, by way of non-limiting example, such as is described in Stratasys U.S. Patent No., 6,022,207 and MakerBot U.S. Pat. No. 9,233,504, the contents of which are incorporated by reference in their entireties. The spool chip may be any electronically readable device, such as an electronically readable and writeable circuit board or EPROM device. The spool chip can be configured to store and update data, specifications and other information about the filament wound on the spool. The spool chip acts as a data tag and may include a variety of functions. For example, characteristic data stored on the spool chip may include at least one of a material identification number, a build material type, a build material diameter, an extruder temperature requirement, a build material melting temperature, a build material color, a build material color lot number, a cost per unit of build material, a build material density, a build material tensile strength, a build material viscosity, a build material recycle code, a build material expiration date, or other characteristic information appropriate for a three-dimensional printer. The spool chip may also be used for tracking the lineal feet of filament on the spool. The data can include nonexecuting code that includes information such as the length of filament remaining on the spool, the type of material, the average outer diameter of the filament, the batch number, the number of times the spool has been loaded into a 3D printer, the storage conditions necessary for holding the filament spool in the cabinet, etc. The 3D printer may interrogate the spool chip to verify the spool material information and OEM confirmation, keep track of the length or volume of material withdrawn from the spool during printing, or verify or monitor other data related to the material on the spool. In another aspect, the spool chip may encode a unique identifier for the consumable assembly, which can be used by the printer, e.g., in combination with a remote network resource, to determine properties of the build material from which to further determine operational parameters for a fabrication process using the build material. The material type information may be used by the printer to configure machine parameters suitable for fabricating parts from that particular material.

Printer control 120 uses build instructions 114, material identifications 124 and a parameter file 126 to generate hardware instructions 128 that are provided to printer hardware 130. Hardware instructions 128 cause printer hardware 130 to add part material and support material to the part under construction 104 in the sequence laid out by build instructions 114. In creating hardware instructions 128, print control 120 uses material identifications 124 to select parameters set for the particular materials in parameter file 126. Typically, this involves selecting thousands of parameters from parameter file 126. These parameters control the temperatures at which the materials are heated to, the pressures applied to the materials during different parts of the build process, the print head velocity profile, and the electrical signals applied to the printer hardware to cause the hardware to move within the printer during the build process. These parameters take into account delays inherent in printer hardware 130 between when an instruction is sent to printer hardware 130 and when the hardware is able to react. In addition, the parameters are set to accommodate the thermal and mechanical characteristics of the materials so as to ensure a successful build of the part.

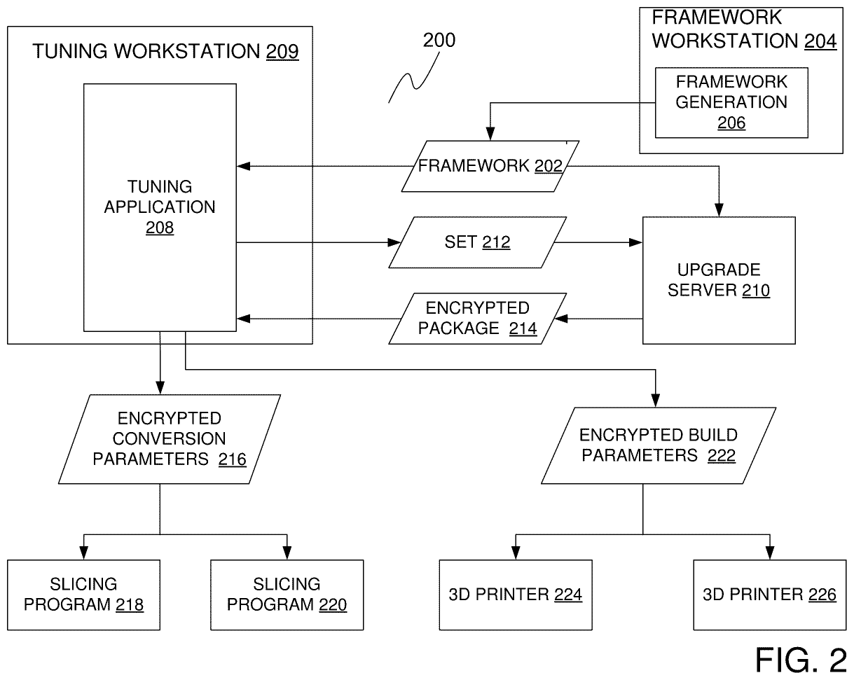

FIG. 2 provides a block diagram of a system 200 for generating parameter files 112 and 126. System 200 allows parameter files to be generated for multiple materials and printers at the same time and allows a parameter file to be sent to multiple slicing programs and multiple printers.

The formation of parameter files 112 and 126 begins with the creation of a framework 202 using framework generation software 206 in a framework workstation 204. Framework 202 includes an identification of tunable parameters, allowable value ranges for those parameters, values for fixed parameters, and functions that describe how variable parameters are calculated from the tunable parameters. In accordance with one embodiment, this information is provided for each of a collection of profiles where each profile is defined by a combination of a part material, a support material, a printer type, a tip size, and a slice height.

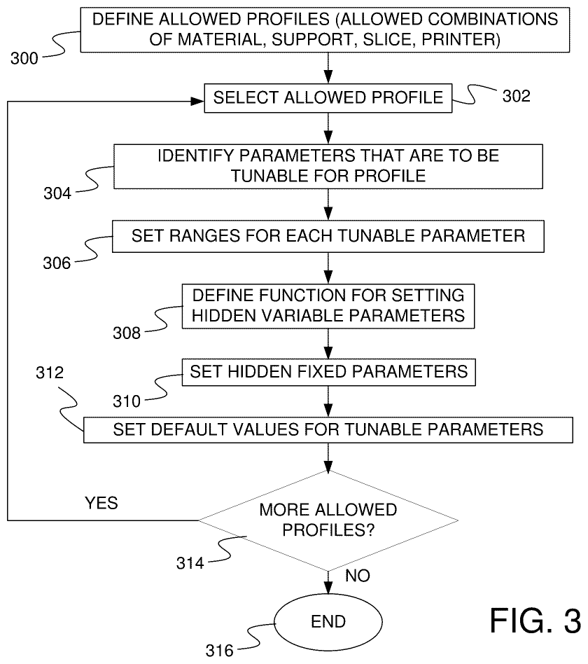

FIG. 3 provides a flow diagram for generating framework 202 in accordance with one embodiment. In step 300, a collection of allowed profiles are defined where each profile represents a combination of a part material, a support material, a printer, a tip size, and a slice height. Thus, for each printer, there will be multiple profiles with at least one profile for each part material that can be used with printer. Similarly, for each part material, there will be multiple profiles with a separate profile for each printer that the material can be used in.

In step 302, one of the allowed profiles is selected and at step 304, parameters that are to be tunable for the profile are identified. In accordance with one embodiment, the tunable parameters are chosen from a set of part-centric parameters that describe how the part changes during the build process instead of being machine-centric parameters that describe the internal workings of the printer or build sequencing application. Such part-centric parameters are easier for users to understand if the users are not familiar with the internal workings of the printers or build sequencing applications.

At step 306, a range is set for each tunable parameter which limits the values that a user can select for the parameter. For example, a tunable parameter for the heating temperature of a material can be limited so that the material is not degraded by being overheated from either the material extruder, or by the oven chamber.

At step 308, functions are defined for setting hidden variable parameters based on the tunable parameters. The hidden variable parameters are parameters that are hidden from users but that must be changed when the value of a tunable parameter is changed. The functions allow an upgrade server to automatically set these hidden parameters based on the values of the tunable parameters that the server receives as discussed further below.

At step 310, parameters that are not a function of the tunable parameters, known as hidden fixed parameters, are set. The values for the hidden fixed parameters are generally set through a lengthy tuning process that identifies parameter values that will most often result in successful part builds for a particular printer and material. At step 312, default values are set for each of the tunable parameters where the default values are once again selected to have values that are most likely to result in successful builds based on the material type chosen.

The process of FIG. 3 then determines if there are more allowed profiles that need to be processed at step 314. If there are more allowed profiles, the process returns to step 302 and a next allowed profile is selected. When there are no more allowed profiles, framework 202 is complete and the process of FIG. 3 ends at step 316.

Once framework 202 has been constructed, it can be used in a tuning application 208 executed in a workstation 209 of FIG. 2 to tune the tunable parameters of one or more profiles defined in the framework. In accordance with one embodiment, tuning application 208 does not alter the information provided in framework 202. Instead, tuning application 208 produces profile instances, where each profile instance consists of a name for the profile instance, the information that identifies the profile (printer, part material, support material, tip size, slice height) and values for the parameters that have been designated as tunable for that profile. Note that multiple profile instances can be created for a single profile, with each profile instance having a different name and different values for the tunable parameters.

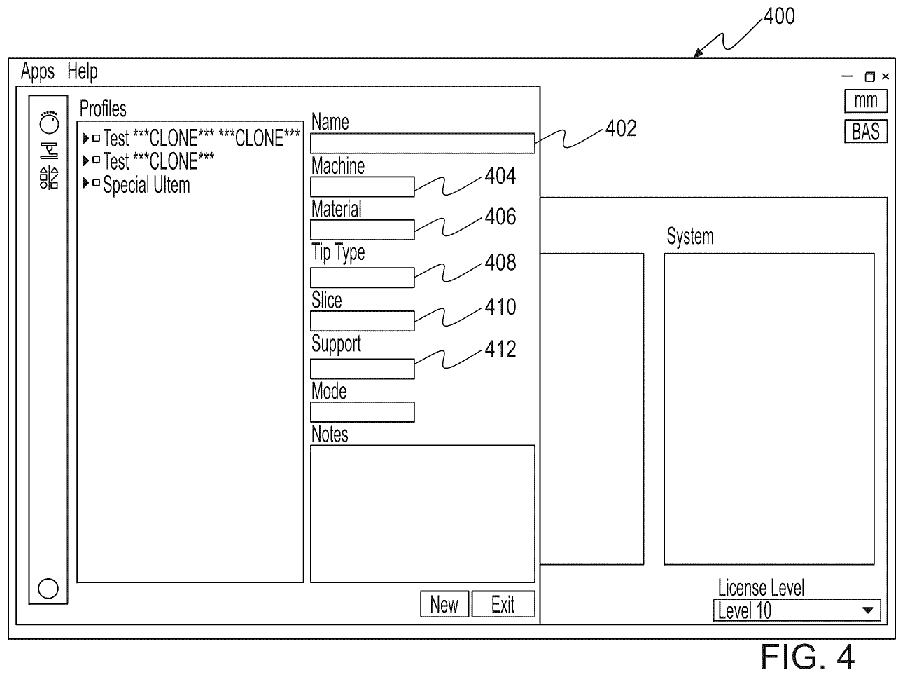

FIG. 4 provides an example of a user interface 400 produced by tuning application 208 for defining a profile instance. In FIG. 4, a user enters a name for the profile instance in box 402. The user then selects a printer type in machine box 404. In accordance with one embodiment, the printer type selected from box 404 is selected from a dropdown or pulldown menu that is generated from framework 202. In particular, every printer type found in the profiles of framework 202 is provided as a selectable option in the pulldown menu. After the user has selected a printer type in box 404, the user selects a part material from material box 406 (e.g., either a generic part material type or an OEM part material). In accordance with one embodiment, the material is selected using a pulldown menu that is populated with material types that are found in at least one profile for the printer type selected in box 404. Thus, only the materials that appear in at least one profile of framework 202 for the printer type selected in box 404 are presented in material box 406. The user then selects a tip dimension from tip dimension box 408. In accordance with some embodiments, the tip dimension is selected from a pulldown menu that is populated with each tip dimension that appeared in at least one profile that contained both the printer type in printer box 404 and the part material in material box 406. The user then enters a slice height in slice box 410, which once again is performed using a pulldown menu. The pulldown menu is populated with slice heights that are found in at least one profile containing the printer, part material and tip dimension of boxes 404, 406 and 408, respectively. Lastly, the user selects a support material using support material box 412. The support material is selected using a pulldown menu containing a list of support materials that appear in at least one profile containing the printer, parts material, tip dimension, and slice height in boxes 404, 406, 408 and 410. In accordance with one embodiment, each material type in the material box 406 and each support material in the support material box 412 has an associated machine-readable chip that must be detected by a designated printer in order to initiate the build job later in the workflow.

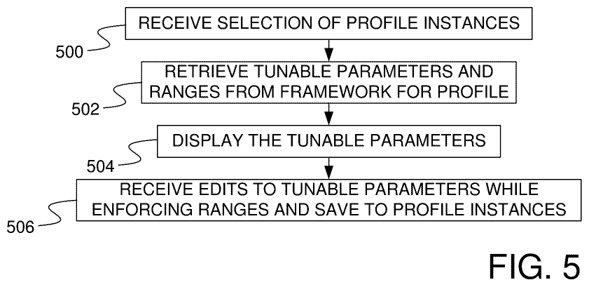

After a profile instance has been created, the tunable parameters within that profile instance may be modified. FIG. 5 provides a flow diagram of a method performed by tuning application 208 to provide for such tuning. In step 500 of FIG. 5, tuning application 208 receives the selection of a profile instance from a list of available profile instances. At step 502, tuning application 208 retrieves the tunable parameters and the ranges for those tunable parameters from framework 202 for the profile associated with the profile instance. At step 504, tuning application 208 displays the tunable parameters with control elements that are limited to the ranges set for each tunable parameter. At step 506, tuning application 208 receives edits to the values of the tunable parameters while enforcing the ranges set for the tunable parameters in framework 202. With each change to a value, tuning application 208 saves the value as part of the profile instance.

The process of FIG. 5 can be performed for as many profile instances as desired. As such, values for tunable build parameters for multiple different combinations of printer type and part material can be received by tuning application 208.

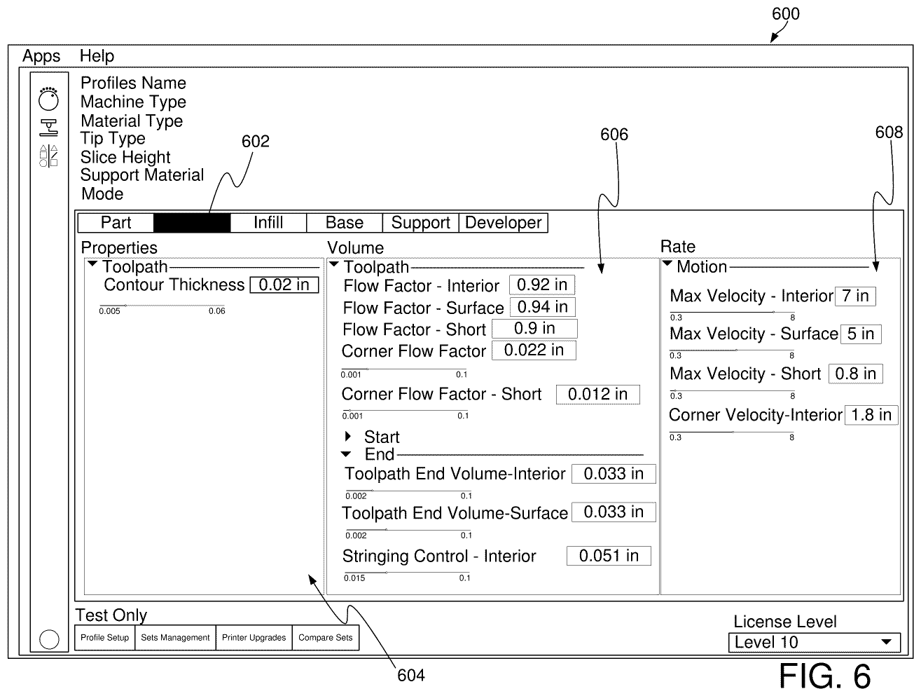

FIGS. 6, 7 and 8 provide exemplary user interfaces 600, 700 and 800, respectively that are used for tuning tunable parameters of a profile instance in accordance with one embodiment.

In FIG. 6, a vertical tab 602 has been selected in user interface 600 and parameters associated with vertical structures in the part are displayed in three columns 604, 606 and 608. Column 606 contains parameters that affect the volume of material applied on vertical structures in the part. Column 608 contains parameters that affect the rate at which material is applied to the part when building vertical structures.

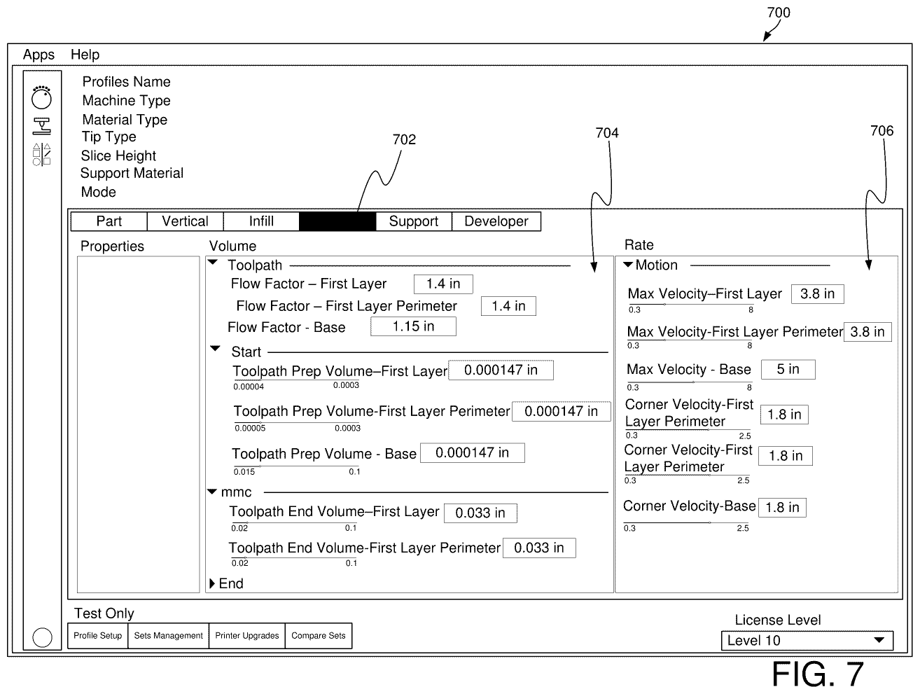

In FIG. 7, base tab 702 has been selected and parameters are shown in two columns 704 and 706 with parameters in column 704 related to the volume of material applied to form the base of a part and column 706 containing parameters that affect the rate at which material is added to the base of a part.

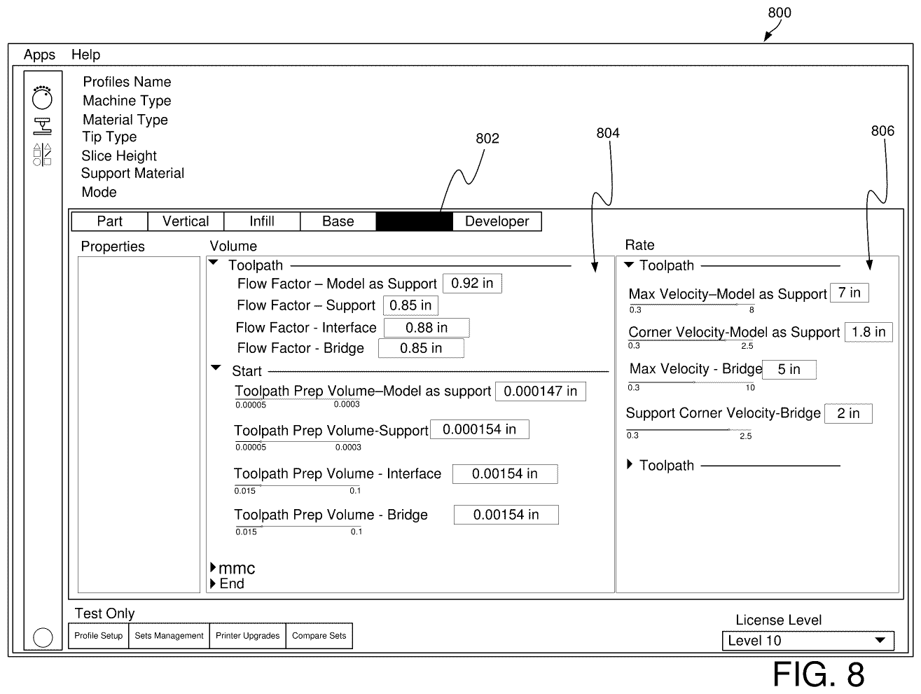

In user interface 800 of FIG. 8, support tab 802 has been selected and parameters are shown in columns 804 and 806 with the parameters in column 804 being related to the volume of support material added supports while building the part and column 806 containing parameters related to the rate at which support material is added to supports.

In FIGS. 6-11, the user is prevented from entering values that exceed the range set for each tunable parameter. Thus, the user is prevented from entering a value that is known to work poorly with the selected profile.

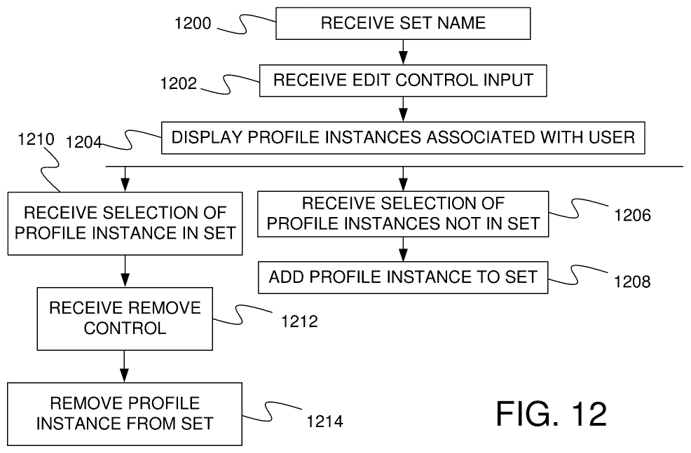

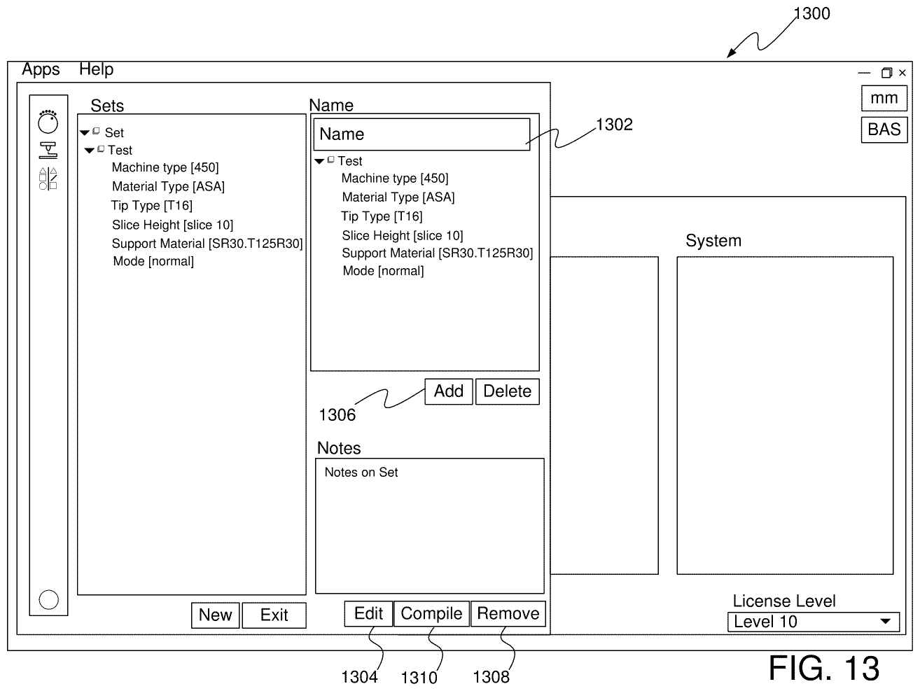

After the values of tunable parameters have been set for one or more profile instances, tuning application 208 is used to request that a collection of profile instances be incorporated into a binary package of parameters that can be installed on one or more slicing programs and one or more printers. FIG. 12 provides a flow diagram for creating the collection of profile instances referred to as a set. FIG. 13 provides an example of a user interface 1300 used to create and edit a set.

In step 1200 of FIG. 12 the name for a set is received in name box 1302 of FIG. 13. At step 1202, an edit control 1304 is selected. In response to edit control 1304 being selected, a list of profiles instances associated with the user is displayed at step 1204. At step 1206, one of the profile instances that is not in the current set is selected along with an Add control 1306. In response, tuning application 208 adds the selected profile instance to the set at step 1208. The user can also remove a profile instance from a set by selecting the profile instance in the set at step 1210 and selecting a remove control 1308 at step 1212. The selected profile instance will then be removed from the set at step 1214.

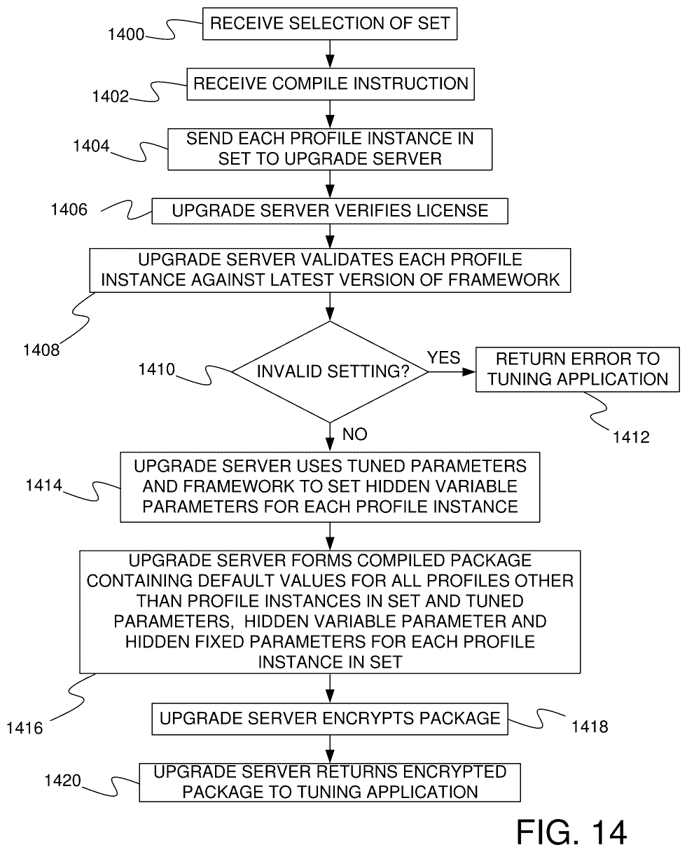

Once all of the desired profile instances have been added to a set, a user may request that the set be complied into an upgrade package that can be installed on one or more slicing programs and one or more printers. FIG. 14 provides a flow diagram of a method of compiling a set into an upgrade package. At step 1400, tuning application 208 receives the selection of a set. In step 1402, tuning application 208 receives the selection of a compile control 1310 of FIG. 13. In response to receiving the compile control selection, tuning application 208 sends the selected set 212 to an upgrade server 210 of FIG. 2 at step 1404, where set 212 includes all of the profile instances that were added to set 212. Upgrade server 210 can take the form of any computing device capable of performing the functions described herein. Note that since sets can include multiple different profile instances, a set can contain values for tunable build parameters for multiple combinations of printer type and part material and step 1404 can involve sending values for multiple combinations of printer type and part material to a server.

At step 1406, upgrade server 210 verifies that the user has the proper licenses to construct upgrade packages from the profile instances. If the user has the correct licenses, the upgrade server validates each profile instance against a latest version of framework 202 at step 1408. This validation includes ensuring that each parameter that was tuned is still tunable under the latest version of framework 202 and to ensure that the values chosen for the tunable parameters are still within the ranges found in the latest version of the framework 202. This validation is performed in case tuning application 208 was using an earlier version of the framework that is no longer valid.

If upgrade server 210 determines that one of the parameters has an invalid setting at step 1410, upgrade server 210 returns an error to tuning application 208 at step 1412.

If all of the tuned parameters are valid at step 1410, upgrade server 210 uses the tuned parameters and the functions found in framework 202 to set the hidden variable parameters for each profile instance at step 1414. Thus, upgrade server 210 uses the functions that described the relationship between the values of the tuned parameters and the values of the hidden variable parameters to set the values of the hidden variable parameters.

At step 1416, upgrade server 210 forms a compiled package that contains the tuned parameters, the hidden variable parameters and the hidden fixed parameters for each profile instance in the set. In addition, the complied package contains default values for all other profiles in the framework. As such, any profiles that do not have a profile instance in set 212 will have default values for the tunable parameters, hidden variable parameters and hidden fixed parameters of the profile.

At step 1418, upgrade server 210 encrypts the package and at step 1420, upgrade server 210 returns the encrypted package 214 to tuning application 208. In accordance with one embodiment, encrypted package 214 is a single package containing values for additional build parameters (hidden variable parameters and hidden fixed parameters) for each of multiple two combinations of printer type and part material.

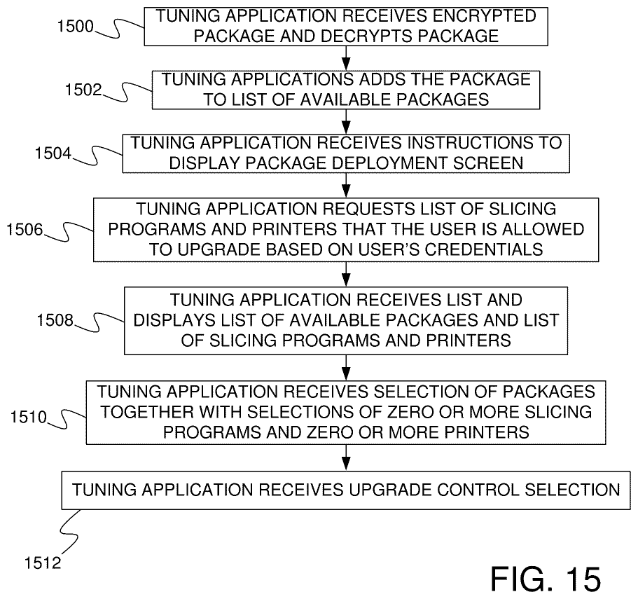

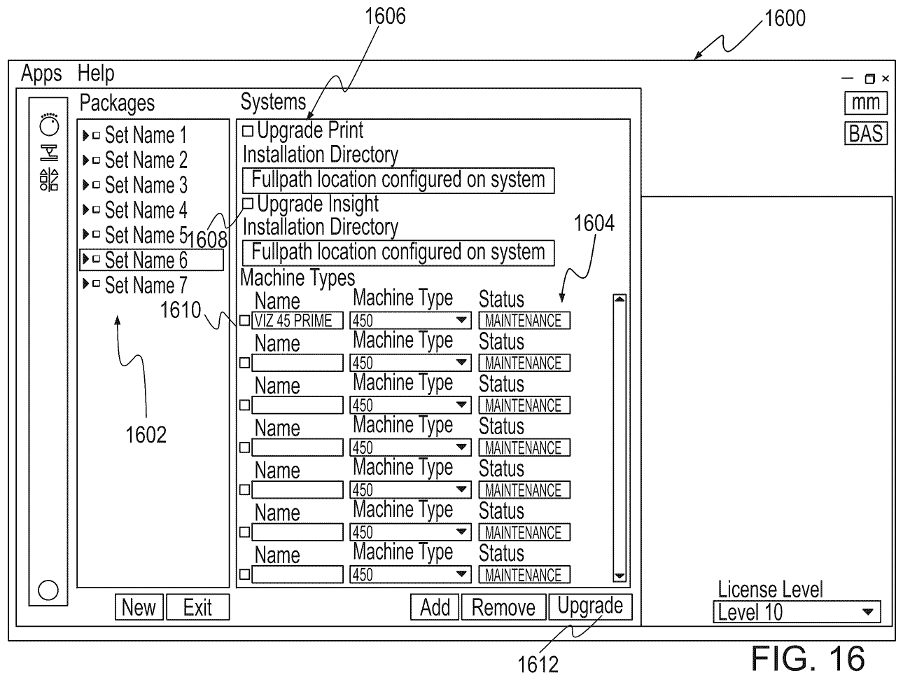

Once tuning application 208 has received encrypted package 214, a user of tuning application 208 can designate one or more slicing programs and one or more printers that are to receive the parameters in encrypted package 214. FIG. 15 provides a flow diagram of a method of designating such slicing programs and printers and FIG. 16 provides a user interface 1600 for designating slicing programs and printers that are to receive parameters from an encrypted package.

In step 1500, tuning application 208 receives encrypted package 214 and decrypts the received package. At step 1502, tuning application 208 adds the package to a list of available packages shown as list 1602 in FIG. 16. At step 1504, tuning application 208 receives an instruction to display package deployment user interface 1600 of FIG. 16. At step 1506, tuning application 208 requests a list of slicing programs and printers that the user of tuning application 208 is allowed to upgrade based on credentials of the user. At step 1508, tuning application 208 receives the list of slicing programs and printers and displays the list of slicing programs and printers together with a list of available packages.

In FIG. 16, the list of printers is shown as printer list 1604 and the list of slicing programs is shown as slicing programs list 1606. Each slicing program and each printer is displayed with a control input, such as check boxes 1608 and 1610, that allow the user to designate which printers and which slicing programs are to receive the package selected in package list 1602.

At step 1510, tuning application 208 receives a selection of a package from package list 1602 together with selections of zero or more slicing programs and zero or more printers from printer list 1604. At step 1512, tuning application 208 receives the selection of an upgrade control 1612 which causes tuning application 208 to install the package on the selected slicing programs and the selected printers.

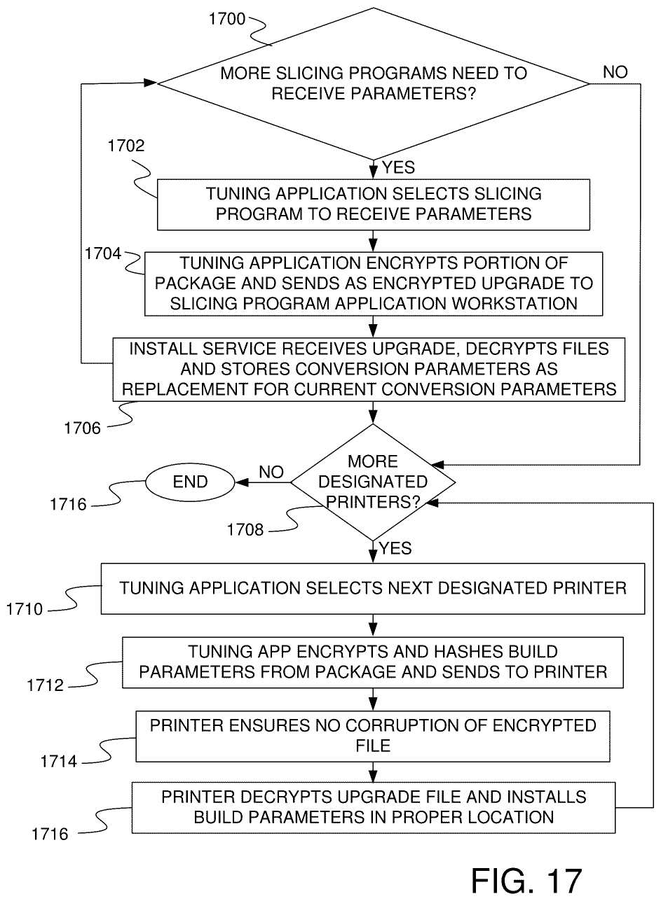

FIG. 17 provides a method by which tuning application 208 installs the packages on the selected slicing programs, such as slicing programs 218 and 220 of FIG. 2, and the selected 3D printers, such as 3D printers 224 and 226 of FIG. 2.

In step 1700, tuning application 208 determines if more slicing programs that were selected still need to receive the parameters. If there are more selected slicing programs that still need to receive the parameters, tuning application 208 selects one of the slicing programs that still need to receive the parameters at step 1702.

At step 1704, tuning application 208 encrypts a portion of the parameters in the package and sends the encrypted portion as encrypted conversion parameters 216 to a slicing program, such as one of slicing programs 218 and 220 of FIG. 2, at step 1704. In accordance with one embodiment, encrypted conversion parameters 216 are sent to a network address associated with a computing device that the slicing program is installed on. At step 1706, an install service of the computing device that the slicing program is installed on receives encrypted conversion parameters 216, decrypts the conversion parameters and stores the conversion parameters as a replacement for current conversion parameters in parameter file 112 used by the slicing program.

The process of FIG. 17 then returns to step 1700. When there are no more slicing programs that need to receive parameters at step 1700, the process continues at step 1708 where the tuning application 208 determines if there are any more 3D printers that need to receive parameters. If a 3D printer needs to receive the parameters, tuning application 208 selects one of the printers at step 1710 and at step 1712, tuning application 208 encrypts the build parameters received in the package and hashes the encrypted build parameters to produce encrypted build parameters 222. In accordance with one embodiment, encrypted build parameters 222 include additional build parameters (hidden variable parameters and hidden fixed parameters) for multiple combinations of printer type and part material. Tuning application 208 then retrieves a stored network address for the 3D printer and sends encrypted build parameters 222 to the 3D printer, such as one of 3D printers 224 and 226. At step 1714, the printer uses the hash of encrypted build parameters 222 to ensure there has been no corruption of the encrypted file. If the file is not corrupted, the printer decrypts encrypted build parameters 222 and installs the build parameters in a proper location for that printer, such as printer file 126 of FIG. 1. The process then returns to step 1708 to determine if there are any other printers that need to receive build parameters based on the selections made in FIG. 16. If there are other printers that need to receive the build parameters, steps 1710-1714 are repeated for one of the other printers selected for the package. When all of the printers have received the build parameters, the process of FIG. 17 ends at step 1716.

In accordance with one embodiment, the hidden fixed parameters and the hidden variable parameters returned in encrypted package 214 remain hidden from the users of tuning application 208, slicing programs 218 and 220 and 3D printers 224 and 226. This provides a layer of security to the 3D printers that makes it harder for third parties to set malicious values for such parameters since they do not know of the existence of the parameters. In addition, keeping these parameters hidden preserves the trade secrets of the 3D printer's manufacturer.

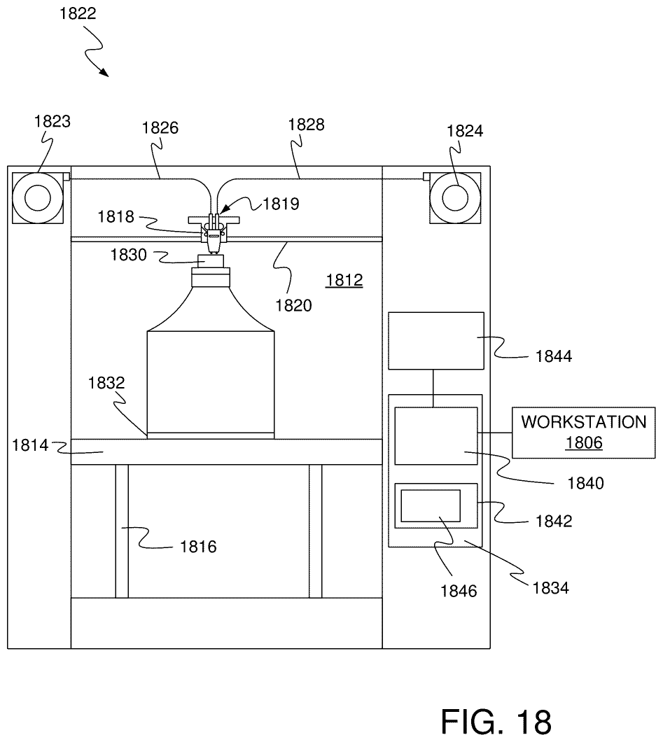

FIG. 18 is a schematic front view of a 3D printer 1822 and workstation 1806, which are examples of 3D printer 122 and workstation 106 of FIG. 1. As shown in FIG. 18, 3D printer 1822 is a material extrusion additive manufacturing system for printing or otherwise building 3D parts and support structures using a layer-based, additive manufacturing technique, where the 3D part can be printed from part material and support structures can be printed from support material. Suitable extrusion-based additive manufacturing systems for 3D printer 1822 include fused deposition modeling systems developed by Stratasys, Inc., Eden Prairie, MN under the trademark “FDM”.

In the illustrated embodiment, 3D printer 1822 includes chamber 1812, platen 1814, platen gantry 1816, an extrusion head or print head 1818, head gantry 1820, and consumable assemblies 1823 and 1824. Chamber 1812 is an enclosed environment that contains platen 1814 and any printed parts. Chamber 1812 can be heated (e.g., with circulating heated air) to reduce the rate at which the part and support materials solidify after being extruded and deposited.

Platen 1814 is a platform on which printed parts and support structures are printed in a layer-by-layer manner. In some embodiments, platen 1814 may also include a removable substrate on which the printed parts and support structures are printed. In the illustrated example, print head 1818 is a dual-tip extrusion head configured to receive consumable filaments from consumable assemblies 1823 and 1824 (e.g., via feed tube assemblies 1826 and 1828) for printing 3D part 1830 and support structure 1832 on platen 1814. Consumable assembly 1823 may contain a supply of a part material filament, such as a high-performance part material, for printing printed part 1830 from the part material. Consumable assembly 1824 may contain a supply of a support material filament for printing support structure 1832 from the given support material. Consumable assemblies 1823 and 1824 constitute holding areas for holding filament materials to be used to print parts. In accordance with one embodiment, supply sources 1823 and 1824 include solid-state memories that store identifiers of the materials loaded in supply sources 1823 and 1824 and thus serve as material identifications 124 of FIG. 1.

Platen 1814 is supported by platen gantry 1816, which is a gantry assembly configured to move platen 1814 along (or substantially along) a vertical z-axis. Correspondingly, print head 1818 is supported by head gantry 1820, which is a gantry assembly configured to move print head 1818 in (or substantially in) a horizontal x-y plane above chamber 1812. In an alternative embodiment, platen 1814 may be configured to move in the horizontal x-y plane within chamber 1812 and print head 1818 may be configured to move along the z-axis. Other similar arrangements may also be used such that one or both of platen 1814 and print head 1818 are moveable relative to each other over a desired number of degrees of freedom. Platen 1814 and print head 1818 may also be oriented along different axes. For example, platen 1814 may be oriented vertically and print head 1818 may print printed part 1830 and support structure 1832 along the x-axis or the y-axis.

The print head 1818 can have any suitable configuration. In one example, the print head 1818 includes a filament drive mechanism 1819, a heated-tube liquefier, and an extrusion nozzle. The liquefier includes an inlet which often is cooled to prevent melting of the filament as it enters the liquefier and a heated melt region, which may include one or more heating zones, where the filament melts to form a molten pool. The filament drive mechanism 1819 engages the filament and feeds the filament into the liquefier at a controlled rate. The unmelted portion of the filament essentially fills the inlet of the liquefier tube, providing a plug-flow type pumping action to extrude the molten filament material from the extrusion nozzle to form a continuous flow or toolpath of resin material. During a build operation, one or more drive mechanisms, such as filament drive mechanism 1819 and a filament loading drive, are directed to intermittently feed the part and support materials (e.g., consumable filaments via feed tube assemblies 1826 and 1828) through the printer to print head 1818 from supply sources 1823 and 1824, and into the liquefier. The extrusion rate is unthrottled and is based only on the feed rate of filament into the liquefier, and the feed rate is calculated to achieve a targeted extrusion rate for the part build. The print head is moved along toolpaths at a controlled rate matched to the extrusion rate, as the extruded flow of material is deposited as beads of material to form cross-sections of the part (typically, in planar layers, but toolpaths can be multi-axis). The deposited material fuses to previously deposited material and solidifies upon a drop in temperature.

3D printer 1822 also includes printer control 1834, which can include one or more control circuits configured to monitor and operate the components of 3D printer 1822 and which is an instance of printer control 120 of FIG. 1. For example, printer control 1834 can control one or more printer hardware components such as heating units for chamber 1812, one or more heaters in print head 1818, the motors of gantries 1820 and 1816, drive mechanism 1819 and the filament loading drive. In addition, printer control 1834 receives sensor signals from various sensors and calibration devices in 3D printer 1822, including temperature sensors. Printer control 1834 includes a processor 1840 and a data storage 1842, which stores instructions executed by processor 1840 and build parameters 1846 provided by tuning application 208. Build parameters 1846 are an instance of parameter file 126 of FIG. 1. Printer control 1834 is connected to a user interface 1844 to provide text and images on user interface 1844 and to receive information from a user through user interface 1844. In accordance with one embodiment, user interface 1844 is a touch screen.

Printer control 1834 communicates with workstation 1806, which provides a build sequence to printer control 1834 based on a digital file that describes the part and conversion parameters provided by tuning application 208.

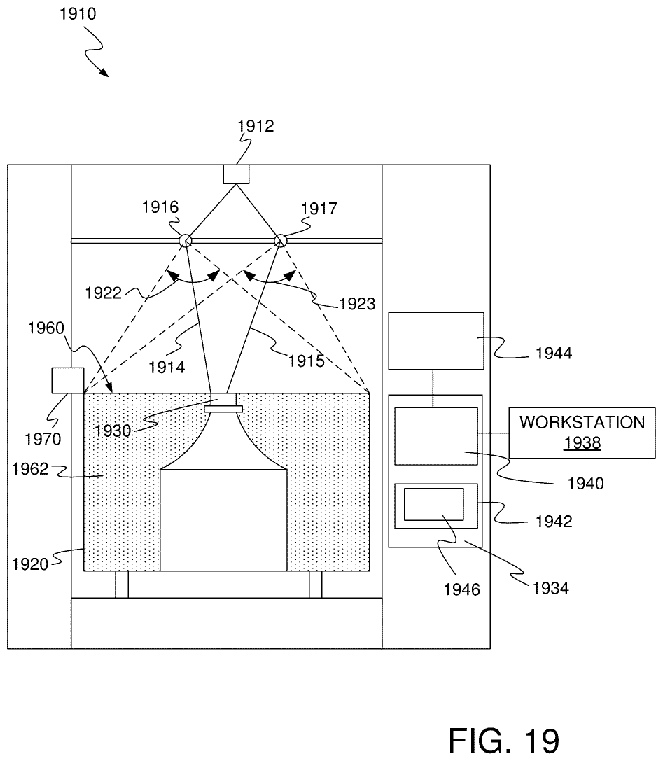

FIG. 19 provides a schematic diagram of a 3D printer 1910 and workstation 1938, which are second examples of 3D printer 122 and workstation 106 of FIG. 1. In 3D printer 1910, vat photopolymerization technology embodiments are practiced. 3D printer 1910 constructs parts using stercolithography 3D printing. In general, to print parts using stercolithography, a thin layer of a liquid photopolymer material is coated evenly across a vat and a laser scanner control mechanism is operated to move one or more laser beams and to modulate the energy level per unit area of the laser beams to selectively cure a pattern in the photopolymer layer coated in the vat. When one layer is complete, another layer of liquid photopolymer is coated over the previous layer, and the next layer is scanned. This process is repeated until the part is built. In accordance with some embodiments, to keep the top layer of photopolymer the same distance from the laser, the entire vat is moved downward relative to the laser each time a layer is recoated in the vat.

As illustrated in FIG. 19, 3D printer 1910 includes a laser source 1912 that produces one or more laser beams 1914, 1915. 3D printer 1910 further includes one or more scanners 1916, 1917 where scanner 1916 is configured to direct laser beam 1914 of the plurality of laser beams onto a top layer 1960 of liquid photopolymer material 1962 in vat 1920, and scanner 1917 is configured to direct a laser beam 1915 of the plurality of laser beams onto top layer 1960 of liquid photopolymer material 1962 in vat 1920. Laser source 1912 may be a single laser emitter and a corresponding optical system configured to split a first laser beam into a plurality of second laser beams for processing. Alternatively, the laser source 1912 may comprise a plurality of laser emitters, each configured to concurrently emit a single laser beam. The laser beams 1914, 1915 are directed from the laser source 1912 to the respective scanner 1916, 1917. Each scanner 1916, 1917 is configured to direct an incident laser beam 1914, 1915 within a scan area (indicated by angle 1922, 1923) on top layer 1960 of liquid photopolymer 1962 in vat 1920. Each of the scan areas generally corresponds to and covers at least a portion of top layer 1960. The laser energy of each incident laser beam 1914, 1915 transfers to top layer 1960 causing the liquid photopolymer material to cure. After the top layer 1960 is cured, a recoater blade 1970 traverses the build area to coat a next layer of liquid photopolymer material 1962 across the vat 1920.

3D printer 1910 also includes printer control 1934, which can include one or more control circuits configured to monitor and operate the components of 3D printer 1910. For example, printer control 1934 can control a heating unit for a chamber that houses vat 1920, the intensity of the laser generated by laser emitter 1912, the focusing of the laser beams, and the rate of scanning of scanners 1916, 1917, for example. In addition, printer control 1934 receives sensor signals from various sensors and calibration devices in system 1910. Printer control 1934 includes a processor 1940 and a data storage 1942, which stores instructions executed by processor 1940 and build parameters 1946 received from tuning application 208. Printer control 1934 is connected to a user interface 1944 to provide text and images on user interface 1944 and to receive information from a user through user interface 1944. In accordance with one embodiment, user interface 1944 is a touch screen. Printer control 1934 communicates with workstation 1938, which provides a build sequence to printer control 1934 based on a digital file that describes the part and conversion parameters provided by tuning application 208.

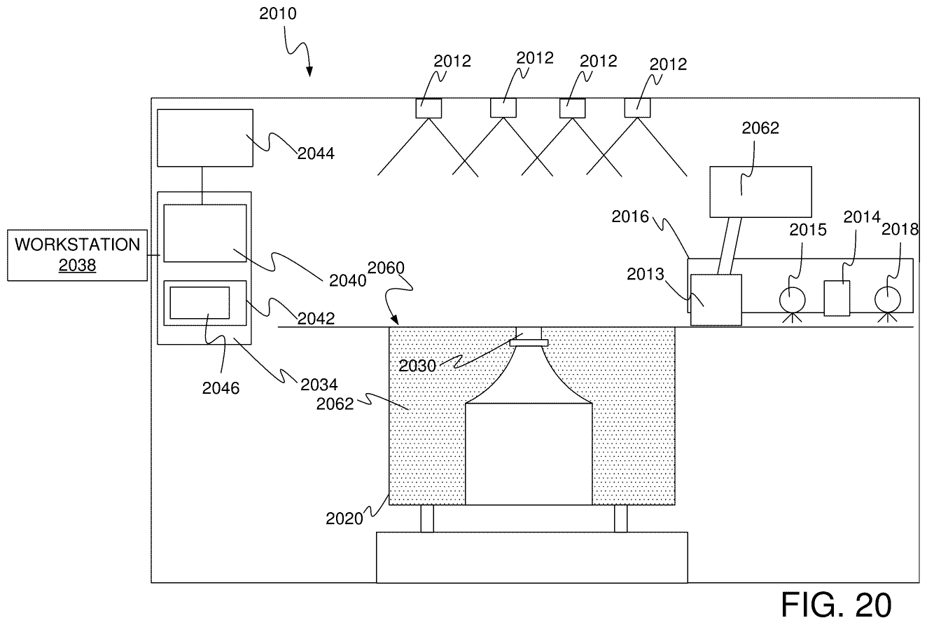

FIG. 20 provides a schematic diagram of a 3D printer 2010 and workstation 2038, which are third examples of 3D printer 122 and workstation 106 of FIG. 1. 3D printer 2010 constructs parts using high speed sintering. In general, to print a part using high speed sintering, a thin layer of powder material is first dispensed evenly in a part bed by a powder recoater (for instance, a counter-rotating roller or a blade) traveling over the part bed. An inkjet print head then images a part layer by spraying radiation-absorbing ink onto selected portions of the powder material. The part bed is then exposed to radiation, for example infrared radiation provided by a sintering lamp that traverses the part bed, wherein the radiation is absorbed more by the portions imaged by the absorber than by the pure powder material thereby causing the imaged portions to heat faster than the unprinted powder. When the imaged portions are sufficiently heated, they sinter while the unprinted powder remains loose. After sintering, the part bed is lowered by one layer thickness. This process is repeated until the assembly of a part is completed.

As illustrated in FIG. 20, 3D printer 2010 includes a powder recoater 2013 configured to distribute a layer of a powder material 2062 onto a part bed 2020, and overhead radiation sources 2012 that emit light toward part bed 2020 to pre-heat the powder. Optionally, a preheating lamp 2015 carried by a sled 2016 is used to further pre-heat the powder by traversing the part bed 2020.

A print head 2014 is moved on the sled 2016 (or on a separate sled) over top surface 2060 of powder material 2062. As it is moved, print head 2014 sprays radiation-absorbing ink to print an image of one layer of the part. Once the image is printed, sintering lamp 2018 is moved on sled 2016 (or on a separate sled) over the part bed 2020, and the radiation from sintering lamp 2018 causes the imaged powder to sinter and form a part layer. Radiation sources 2012 and the sintering lamp 2018 may comprise halogen lamps, either modular or a full width single bulb; arrays of infrared radiation (IR) lamps, arrays of light-emitting diodes (LEDs); ceramic lamps; or any other suitable radiation emitter. The wavelength of the light emitted by the sintering lamp 2018 is selected to be readily absorbed by the absorber while not being readily absorbed by the powder material.

3D printer 2010 also includes a printer control 2034, which can include one or more control circuits configured to monitor and operate the components of 3D printer 2010. For example, printer control 2034 can control a heating unit for a chamber the houses part bed 2020, the intensity of radiation sources 2012, the speed and acceleration of the sled(s) 2016 carrying the powder recoater, the print head 2014, the pre-heat lamp, and the sintering lamp 2018, the amount of time between printing the ink and dispensing a new layer of powder material, and the thickness of the powder material for each layer. In addition, printer control 2034 receives sensor signals from various sensors and calibration devices in 3D printer 2010.

Printer control 2034 includes a processor 2040 and a data storage 2042, which stores instructions executed by processor 2040 and build parameters 2046 received from tuning application 208. Controller 2034 is connected to a user interface 2044 to provide text and images on user interface 2044 and to receive information from a user through user interface 2044. In accordance with one embodiment, user interface 2044 is a touch screen. Printer control 2034 communicates with workstation 2038, which provides a build sequence to printer control 2034 based on a digital file that describes the part and conversion parameters provided by tuning application 208.

Although three 3D printers are discussed above so as to provide examples of environments in which the present embodiments can be practiced, those skilled in the art will recognize that the embodiments may be practiced in other 3D printers and the embodiments are not limited to the 3D printers shown in FIGS. 18-20.

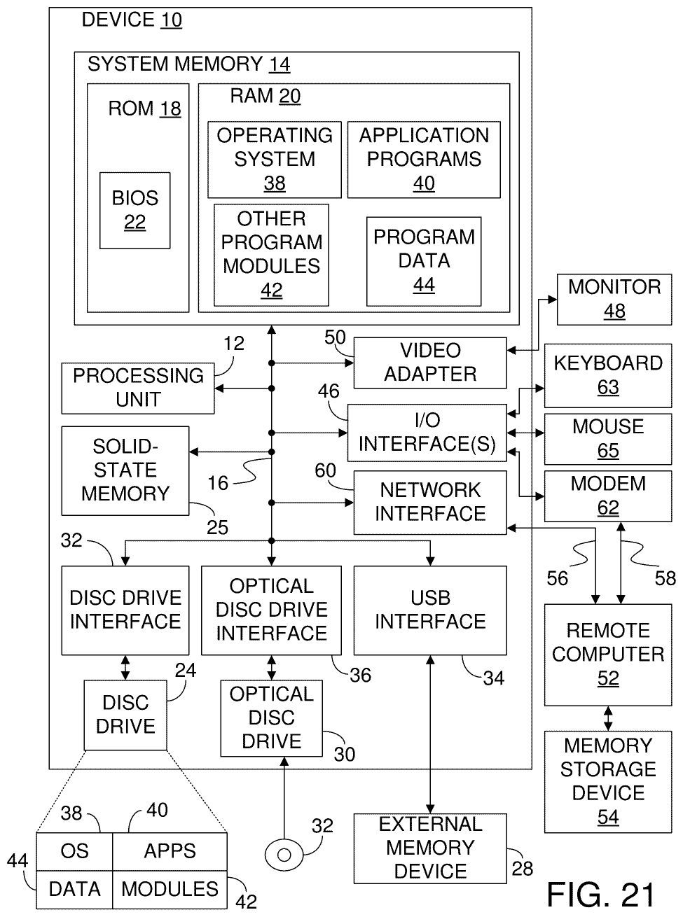

FIG. 21 provides an example of a computing device 10 that can be used to implement one or more of the workstations/computing devices discussed above. Computing device 10 includes a processing unit 12, a system memory 14 and a system bus 16 that couples the system memory 14 to the processing unit 12. System memory 14 includes read only memory (ROM) 18 and random-access memory (RAM) 20. A basic input/output system 22 (BIOS), containing the basic routines that help to transfer information between elements within the computing device 10, is stored in ROM 18. Computer-executable instructions that are to be executed by processing unit 12 may be stored in random access memory 20 before being executed.

Computing device 10 further includes an optional hard disc drive 24, an optional external memory device 28, and an optional optical disc drive 30. External memory device 28 can include an external disc drive or solid-state memory that may be attached to computing device 10 through an interface such as Universal Serial Bus interface 34, which is connected to system bus 16. Optical disc drive 30 can illustratively be utilized for reading data from (or writing data to) optical media, such as a CD-ROM disc 32. Hard disc drive 24 and optical disc drive 30 are connected to the system bus 16 by a hard disc drive interface 32 and an optical disc drive interface 36, respectively. The drives and external memory devices and their associated computer-readable media provide nonvolatile storage media for the computing device 10 on which computer-executable instructions and computer-readable data structures may be stored. Other types of media that are readable by a computer may also be used in the exemplary operation environment.

A number of program modules may be stored in the drives and RAM 20, including an operating system 38, one or more application programs 40, other program modules 42 and program data 44. In particular, application programs 40 can include programs for implementing any one of the applications discussed above. Program data 44 may include any data used by the systems and methods discussed above.

Processing unit 12, also referred to as a processor, executes programs in system memory 14 and solid-state memory 25 to perform the methods described above.

Input devices including a keyboard 63 and a mouse 65 are optionally connected to system bus 16 through an Input/Output interface 46 that is coupled to system bus 16. Monitor or display 48 is connected to the system bus 16 through a video adapter 50 and provides graphical images to users. Other peripheral output devices (e.g., speakers or printers) could also be included but have not been illustrated. In accordance with some embodiments, monitor 48 comprises a touch screen that both displays input and provides locations on the screen where the user is contacting the screen.

The computing device 10 may operate in a network environment utilizing connections to one or more remote computers, such as a remote computer 52. The remote computer 52 may be a server, a router, a peer device, or other common network node. Remote computer 52 may include many or all of the features and elements described in relation to computing device 10, although only a memory storage device 54 has been illustrated in FIG. 21. The network connections depicted in FIG. 21 include a local area network (LAN) 56 and a wide area network (WAN) 58. Such network environments are commonplace in the art.

The computing device 10 is connected to the LAN 56 through a network interface 60. The computing device 10 is also connected to WAN 58 and includes a modem 62 for establishing communications over the WAN 58. The modem 62, which may be internal or external, is connected to the system bus 16 via the I/O interface 46.

In a networked environment, program modules depicted relative to the computing device 10, or portions thereof, may be stored in the remote memory storage device 54. For example, application programs may be stored utilizing memory storage device 54. In addition, data associated with an application program may illustratively be stored within memory storage device 54. It will be appreciated that the network connections shown in FIG. 21 are exemplary and other means for establishing a communications link between the computers, such as a wireless interface communications link, may be used.

The methods and computing devices discussed above improve 3D printing technology by allowing a single copy of tuned parameters to be sent to multiple 3D printers and to multiple build sequencing applications. As a result, users do not have to access each 3D printer and each build sequencing application in order to install the tuned parameters. This greatly simplifies the process for setting tunable parameters in 3D printers and reduces the amount of time needed to find the optimum parameters for a part or a collection of parts. In addition, the embodiments allow multiple profiles to be compiled together into a single package. As a result, tunable parameters for different combinations of printers and materials can be sent at the same time to multiple different 3D printers. This allows for parallel evaluation of different combinations of printers and materials thereby decreasing the time needed to find the best combination of printer, material and parameters for a part or a collection of parts.

Although the subject of this disclosure has been described with reference to several embodiments, workers skilled in the art will recognize that changes may be made in form and detail without departing from the spirit and scope of the disclosure. In addition, any feature disclosed with respect to one embodiment may be incorporated in another embodiment, and vice-versa.

1. A method comprising:
providing values for a set of user-tunable build parameters corresponding to a print job specification in a first user interface;
allowing user selection of settings for parameters in the set of user-tunable build parameters to thereby generate a set of user-selected build parameters;
computing values for a set of additional build parameters based on the set of user selected build parameters;
generating a data package based on the set of user-selected build parameters and the set of additional build parameters; and
sending the data package to one or more designated 3D printers.

2. The method of claim 1 further comprising providing a second user interface that allows a user to select which 3D printers are to be sent the values for the set of additional build parameters.

3. The method of claim 1 wherein the second user interface displays all 3D printers that a set of user credentials is authorized to send values for tunable build parameters to.

4. The method of claim 1 wherein at least some of the values for the set of additional build parameters are determined by the computing device from the values for the set of user-selected build parameters.

5. The method of claim 1 wherein the data package further comprises a value for at least one conversion parameter.

6. The method of claim 5 further comprising providing a user interface that allows a user to select at least one slicing program to receive the value for the at least one conversion parameter.

7. The method of claim 5 wherein the value for the at least one conversion parameter, the values for the set of tunable build parameters and the values for the set of additional build parameters are all associated with the same print job specification, and wherein the print job specification comprises a combination of printer type and part material.

8. The method of claim 7 wherein the print job specification further comprises a support material.

9. The method of claim 7 wherein the print job specification further comprises a slice height.

10. The method of claim 7 wherein the print job specification further comprises a nozzle size.

11. The method of claim 7 and further comprising:
receiving the data package at one of the designated 3D printers;
receiving build instructions at the 3D printer that received the data package;
determining a material loaded in the 3D printer from electronics on a spool holding the material;
using the determined material to utilize the data package and/or select parameters from the data package.

12. The method of claim 7, wherein the part material is a generic material type selected from a list comprising generic material types, and wherein the user-tunable build parameters presented in the first user interface are the default parameters for printing the generic material type.

13. A computer comprising:
a memory having executable instructions; and
a processor executing the executable instructions to perform steps comprising:
receiving values for tunable build parameters for at least two combinations of printer type and part material;
sending the received values for the at least two combinations of printer type and part material to a server;
receiving a single package from the server containing values for additional build parameters for each of the at least two combinations of printer type and part material; and
sending additional build parameters for the at least two combinations of printer type and part material to a 3D printer such that a part can be printed.

14. The computer of claim of claim 13 wherein sending build parameters for the at least two combinations of printer type and part material to a 3D printer comprises sending the build parameters for the at least two combinations of printer type and part material to multiple 3D printers.

15. The computer of claim 14 wherein the processor performs a further step comprising displaying a user interface that provides controls to allow a user to select the multiple 3D printers.

16. The computer of claim 15 wherein the processor performs a further step comprising using a user's credentials to determine which 3D printers appear in the user interface.

17. The computer of claim 13 wherein the at least two combinations of printer type and part material comprises a first combination comprising a first printer type and a first part material and a second combination comprising the first printer type and a second part material.

18. The computer of claim 13 wherein the at least two combinations of printer type and part material comprises a first combination comprising a first printer type and a first part material and a second combination comprising a second printer type and the first part material.

19. The computer of claim 13 wherein at least one of the values for additional build parameters is based on a value for the tunable parameter.

20. A method comprising:
providing values for a set of tunable build parameters to a computing device;
in response, receiving from the computing device values for at least one conversion parameter and a set of additional build parameters; and
sending the value for the at least one conversion parameter to a slicing program and the values for the set of additional build parameters to a 3D printer.

21. The method of claim 20 further comprising sending the values for the set of additional build parameters to a plurality of 3D printers.

22. The method of claim 21 further comprising providing a user interface that allows a user to select which 3D printers are to be sent the values for the set of additional build parameters.

23. The method of claim 22 wherein providing a user interface comprises providing a user interface that allows the user to indicate that the value for the at least one conversion parameter is to be sent to the slicing program.

24. The method of claim 20 wherein at least some of the values for the set of additional build parameters are determined by the computing device from the values for the set of tunable build parameters.

25. The method of claim 20 wherein the value for the at least one conversion parameter, the values for the set of tunable build parameters and the values for the set of additional build parameters are all associated with a same combination of printer type and part material.
